(19) United States
(12) Patent Application Publication
(10) Pub. No.: US 2014/0044910 A1
(43) Pub. Date: Feb. 13, 2014

(54) BADGE FOR ATTACHING AN EXTERNAL OBJECT TO A CLOTH

(71) Applicant: Hao Shi, Redondo Beach, CA (US)

(72) Inventor: Hao Shi, Redondo Beach, CA (US)

(21) Appl. No.: 13/571,783

(22) Filed: Aug. 10, 2012

(51) Int. Cl. B32B 3/06; B32B 33/00; C09J 7/02; B23P 11/00

(52) U.S. Cl. 428/41.7; 29/525.01; 428/99; 428/354; 428/100

(57) ABSTRACT

One example embodiment includes a system for attaching an external object to a cloth. The system includes a badge. The system also includes a first attachment, where the attachment is configured to releasably attach a cloth to the badge. The system further includes a second attachment, where the second attachment is configured to releasably attach a decoration to the badge.

### CROSS-REFERENCE TO RELATED APPLICATIONS

This application is related to co-pending U.S. application Ser. No. ______, filed on ______, 2012, and entitled, “SYSTEM FOR ATTACHING AN EXTERNAL OBJECT TO A CLOTH” (Attorney Docket No. 10371.5), which application is incorporated herein by reference in its entirety.

This application is related to co-pending U.S. application Ser. No. ______, filed on ______, 2012, and entitled, “PROTECTOR FOR PROTECTING AND ATTACHING AN EXTERNAL OBJECT TO A CLOTH” (Attorney Docket No. 10371.6), which application is incorporated herein by reference in its entirety.

### BACKGROUND OF THE INVENTION

Many people use clothing to send a message about themselves. I.e., their selection of clothing is often a reflection of the wearer or of a statement that the wearer intends to make. For example, clothing can include a political or cultural statement. Clothing can reflect a wearer's values or include brand names that the wearer either likes or supports.

However, clothing tends to often be mass produced with the result that many people own the same article. Because of this the wearer may wish to personalize his/her clothing. I.e., the wearer may wish to add certain decorations to his/her clothing. The decorations can include any 3D or 2D object which is added to the clothing. For example, the decorations the wearer desires to add can include a picture or other print.

However, customizing clothing can be an expensive and time consuming process. In particular, printing or adding designs to clothing can require expensive machinery. Often, the cost of such customization requires scale in order to become cost efficient. Therefore, some services which can customize clothing require minimum orders. I.e., an order must include a minimum number of clothing pieces to be customized or the order will be refused.

In addition, the more customization to be done, the more expensive the process. That is, a small amount of text or design costs less than a larger amount of text or design. Therefore, the customization may be limited to a small amount of design. I.e., the cost limitation to a high degree of customization may be difficult to overcome, especially for an individual or small order.

Further, this customization is permanent. I.e., the customization is printed directly onto the clothing and is difficult to remove without damaging the clothing. This means that once the decision has been made to add a certain customization, the decision may be permanent with respect to a particular garment.

Accordingly, there is a need in the art for a system which can allow a user to easily customize clothing. In addition, there is a need in the art for the system to be changeable. Further, there is a need in the art for the customization to allow the addition of larger designs.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a system for attaching an external object to a cloth. The system includes a badge. The system also includes a first attachment, where the attachment is configured to releasably attach a cloth to the badge. The system further includes a second attachment, where the second attachment is configured to releasably attach a decoration to the badge.

Another example embodiment includes a system for attaching an external object to a cloth. The system includes a badge. The badge includes a first portion and a second portion. The second portion is configured to releasably attach to the first portion. The system also includes a first attachment. The first attachment is secured to the first portion and is configured to releasably attach a cloth to the first portion. The system further includes a second attachment. The second attachment is secured to the second portion and is configured to releasably attach a decoration to the second portion.

Another example embodiment includes a method for manufacturing a system for attaching an external object to a cloth. The method includes providing a badge. The method also includes securing a first attachment. The first attachment is secured to the badge and is configured to releasably attach a cloth to the badge. The method further includes securing a second attachment. The second attachment is secured to the second attachment and is configured to releasably attach a decoration to the badge.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates an example of a system for customizing a cloth;

FIG. 2 illustrates an example of the system attaching a decoration to a cloth;

FIG. 3 illustrates an alternative system 300 for customizing a cloth;

FIG. 4 illustrates the alternative system for customizing a cloth indirectly securing the 3D decoration;

FIG. 5 is a flow chart illustrating a method of manufacturing a system for customizing a cloth;

FIG. 6A illustrates a top perspective view of the system for customizing a cloth;

FIG. 6B illustrates a side view of the alternative system for customizing a cloth;

FIG. 7 illustrates an example of the alternative system attaching a decoration to a cloth;

FIG. 8 illustrates that the system 600 can include one or more notches 802;

FIG. 9 is a flow chart illustrating a method of manufacturing a system for customizing a cloth;

FIG. 10A illustrates an arch for attaching the second portion to an external object;

FIG. 10B illustrates a clip for attaching the second portion to an external object; and

FIG. 10C illustrates a spring loaded clip for attaching the second portion to an external object.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

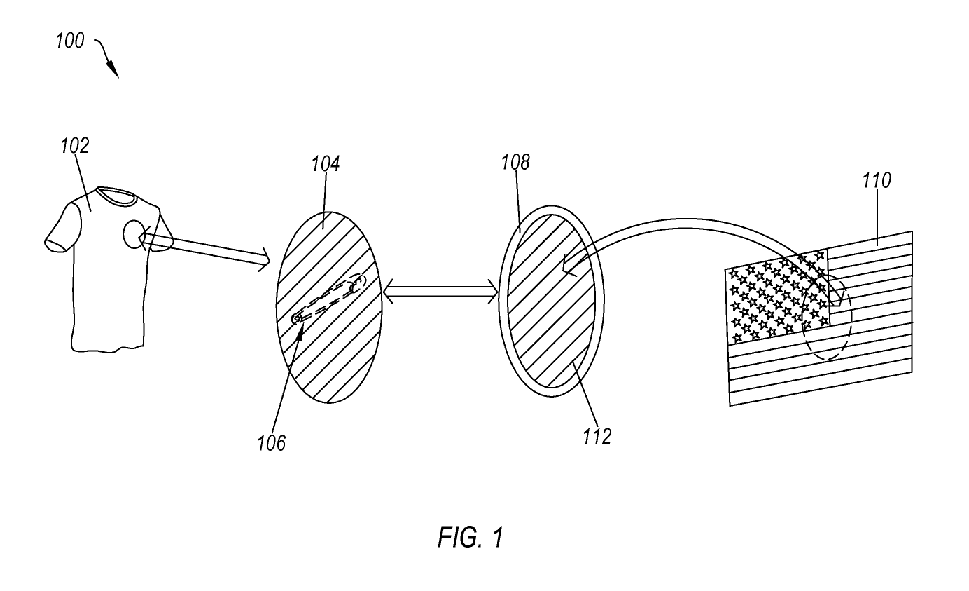

FIG. 1 illustrates an example of a system 100 for customizing a cloth. In at least one implementation, the cloth can include clothing, other cloth and cloth-like materials. I.e., the system 100 can allow a user to customize the look of his/her clothing. Additionally or alternatively, the system 100 can allow the user to customize upholstery or other furniture coverings. One of skill in the art will appreciate that any cloth can be customized and that clothing and cloth are examples and not limiting herein unless otherwise specified in the claims.

FIG. 1 shows system 100 can include a cloth 102. In at least one implementation, the cloth 102 can include any desired material. For example, the cloth 102 can include leather, artificial leather, suede, vinyl, a fabric or any other desired material. The cloth 102 can be used for any desired purpose. For example, the cloth 102 can include clothing, bedding, upholstery covers or any other desired covering or material.

Leather is a durable and flexible material created via the tanning of putrescible animal rawhide and skin, primarily cattlehide. Artificial leather includes any fabric or finish intended to substitute for leather where a leather-like finish is desired but the actual material is cost-prohibitive or unsuitable. Suede includes kid or other leather finished with a soft, napped surface, on the flesh side or on the outer side after removal of a thin outer layer. Vinyl includes any resin formed by polymerization of vinyl compounds or plastics made from such resins. A vinyl compound is any organic compound that contains a vinyl group (Preferred IUPAC name ethenyl). Vinyl groups (formula —CH═CH2) are derivatives of ethene, CH2═CH2, with one hydrogen atom replaced with some other group.

Fabrics include any network of natural or artificial fibers including textiles. In at least one implementation, the fibers can include thread or yarn. For example, yarn can be produced by spinning raw wool fibers, linen, cotton, or other material on a spinning wheel to produce long strands. Fabrics can be formed by weaving, knitting, crocheting, knotting, or pressing fibers together, such as in felt. One of skill in the art will appreciate that a fabric can include a single fiber or more than one fiber.

In at least one implementation, fibers, also spelled fibres, is a class of materials that are continuous filaments or are in discrete elongated pieces. In particular, fibers can be spun into filaments, string or rope, used as a component of composite materials, or matted into sheets to make products such as paper or felt. Additionally or alternatively, fibers can include yarn, thread, string, filaments, twine, cord, or any other material that can be used to form a fabric or cloth. In particular, yarn is a long continuous length of interlocked fibers, suitable for use in the production of textiles, sewing, crocheting, knitting, weaving, embroidery and rope making. Additionally or alternatively, thread is a type of yarn intended for sewing by hand or machine. Yarn and/or thread may be finished with wax or other lubricants to withstand the stresses involved in sewing or otherwise manufacturing the fabric.

Natural fibers can include animal fibers such as alpaca, angora, bison down, camel hair, cashmere, catgut, chiengora, guanaco, llama, mohair, pashmina, qiviut, rabbit, silk, sinew, spider silk, wool, vicuna, and yak; vegetable fibers such as aback bamboo, coir, cotton, flax, hemp, jute, kapok, kenaf, piña, raffia palm, ramie, sisal, and wood; mineral fibers such as asbestos, basalt, mineral wool, and glass wool; and cellulose fibers such as acetate, art silk, bamboo, lyocell (tencel), modal, and rayon; or any other natural fiber. Synthetic fibers can include acrylic, aramid (twaron, kevlar, technora, and nomex), carbon (tenax), derclon, microfiber, modacrylic, nylon, olefin, polyester, polyethylene (dyneema, spectra), spandex, vinalon, zylon, or any other synthetic fiber. One of skill in the art will appreciate that fibers can include any natural or synthetic fibers, or any combination thereof, without restriction and without limitation unless otherwise indicated in the claims.

In at least one implementation, the fibers can be used to form a grid. In particular, the first set of fibers can be oriented in a “horizontal” direction; that is, the first set of fibers can be oriented parallel to one another. One of skill in the art will appreciate that horizontal orientation refers to an arbitrary orientation and is not used to limit or restrict the scope of the claims unless otherwise indicated in the claims. Further, the first set of fibers can be spaced equidistant from one another or in a repeating pattern. For example, a first fiber in the first set of fibers might be relatively close to a second fiber in the first set of fibers, which is, in turn, relatively farther from a third fiber in the first set of fibers, with the pattern repeating throughout the fabric. One of skill in the art will appreciate that the spacing of the first set of fibers can be any distance from one another without restriction and without limitation unless otherwise indicated in the claims.

The second set of fibers can be oriented in a “vertical” direction; that is, the second set of fibers can be oriented parallel to one another. One of skill in the art will appreciate that vertical orientation refers to an arbitrary orientation perpendicular to the first set of fibers and is not used to limit or restrict the scope of the claims unless otherwise indicated in the claims. Further, the second set of fibers can be spaced equidistant from one another or in a repeating pattern. For example, a first fiber in the second set of fibers might be relatively close to a second fiber in the second set of fibers, which is, in turn, relatively farther from a third fiber in the second set of fibers, with the pattern repeating throughout the fabric. One of skill in the art will appreciate that the spacing of the second set of fibers can be any distance from one another without restriction and without limitation unless otherwise indicated in the claims.

In at least one implementation, the fibers can be woven together. In particular, weaving is the textile art in which a first set of fibers and a second set of fibers, called the warp and the filling or weft (older woof), respectively, are interlaced with each other to form a fabric or cloth. In particular, the first set of fibers can be held in place while the second set of fibers is woven through them or vice versa. The manner in which the first set of fibers and the second set of fibers interlace with each other is known as the weave. In particular, the weave can include plain weave, satin weave, and twill or any other type of weave.

In at least one implementation, plain weave can include the first set of fibers and second set of fibers aligned so they form a simple criss-cross pattern. Each fiber in the second set of fibers crosses the first set of fibers by going over one, then under the next, and so on. The next fiber in the second set of fibers goes under the first set of fibers that its neighbor went over, and vice versa. The satin weave is characterized by four or more fibers in the second set of fibers floating over a fiber in the first set of fibers or vice versa, four or more fiber in the first set of fibers floating over a single fiber in the second set of fibers. Twill is a type of fabric woven with a pattern of diagonal parallel ribs. It is made by passing the second set of fibers over one or more first set of fibers and then under two or more first set of fibers and so on, with a “step” or offset between rows to create the characteristic diagonal pattern.

FIG. 1 also shows that the system 100 can include a first portion 104. In at least one implementation, the first portion 104 serves as a “base” or support for a decorative item to be attached to the cloth. The first portion 104 can be sized to accommodate the desired weight. I.e., the first portion 104 can be smaller for smaller objects and larger for larger objects. Additionally or alternatively, the first portion 104 can be shaped as desired. For, example, the first portion 104 can include a rounded shape to prevent sharp edges.

FIG. 1 further shows that the system 100 can include an attachment 106. In at least one implementation, the attachment 106 is configured to attach the first portion 104 to the cloth 102. In particular, the attachment 106 secures the first portion 104 to the cloth 102 and other elements of the system 100 can then be secured to the first portion 104. For example, the attachment 106 can include adhesive, pins, clips, snaps, hook and loop fasteners, magnets, buttons or any other desired attachment.

FIG. 1 additionally shows that the system 100 can include a second portion 108. In at least one implementation, the second portion 108 is configured to attach to the first portion 104. For example, the first portion 104 and the second portion 108 can be magnetically attracted to one another. Additionally or alternatively, the first portion 104 and the second portion 108 can include a hook and loop fastener, a pin, a snap, a button, adhesive or any other desired connection.

FIG. 1 also shows that the system 100 can include a decoration 110. In at least one implementation, the decoration 110 can be attached to the second portion 108. I.e., the decoration 110 is secured to the second portion, which is secured to the cloth 102 via the first portion 104, allowing a user to display the decoration 110 on the cloth 102.

FIG. 1 further shows that the system 100 can include a second attachment 112. In at least one implementation, the second attachment 112 can secure the decoration 110 to the second portion 108. For example, the second attachment 112 can include an adhesive layer. For example, the adhesive layer can include a pressure sensitive adhesive. Pressure sensitive adhesive (PSA, self-adhesive, self-stick adhesive) is adhesive which forms a bond when pressure is applied to marry the adhesive with the adherend. I.e., no solvent, water, or heat is needed to activate the adhesive.

One of skill in the art will appreciate that the second portion 108 need not be present. For example, the first portion 104 can include a mechanism which allows the decoration 110 to be attached directly to the first portion 104. For example, the first portion 104 can include one or more holes, which allows a string to be placed around the decoration 110 and attached to the first portion 104. Additionally or alternatively, the decoration 110 can be attached to the first portion 104 using include a hook and loop fastener, a pin, a snap, a button, adhesive or any other desired connection.

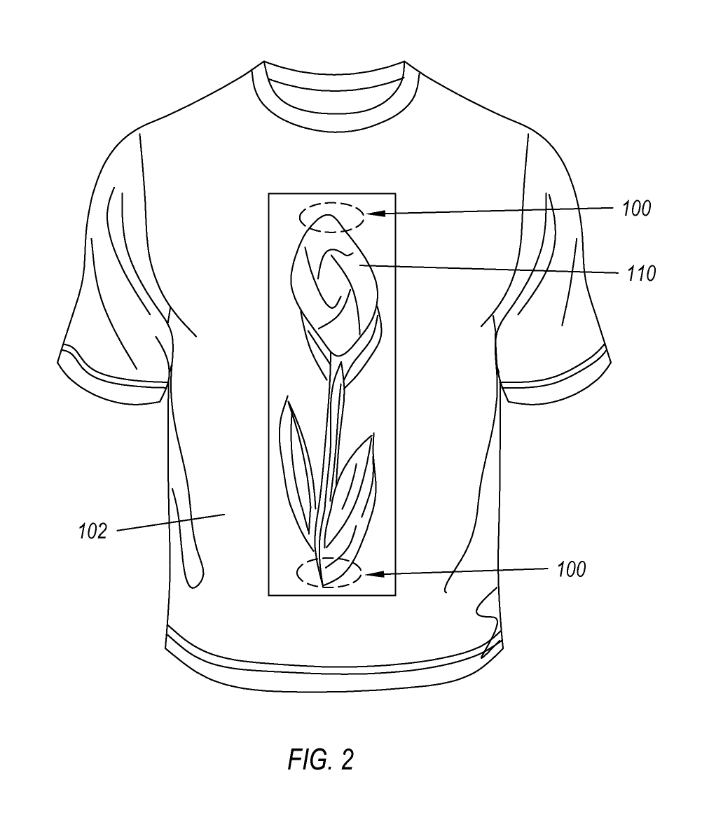

FIG. 2 illustrates an example of the system 100 attaching a decoration 110 to a cloth 102. In at least one implementation, the decoration 110 can be releasably attached to the cloth 102. I.e., the decoration 110 can be attached and removed as desired by the wearer. Additionally or alternatively, different decorations 110 can be attached to the cloth 102, as desired.

FIG. 2 shows that the system 100 can include multiple systems 100 securing the decoration 110. I.e., the system 100 can be used to secure only a portion of the decoration 110. One of skill in the art will appreciate that the attachment used to secure the system 100 to the cloth 102 need not be the same for each of the first portions 104.

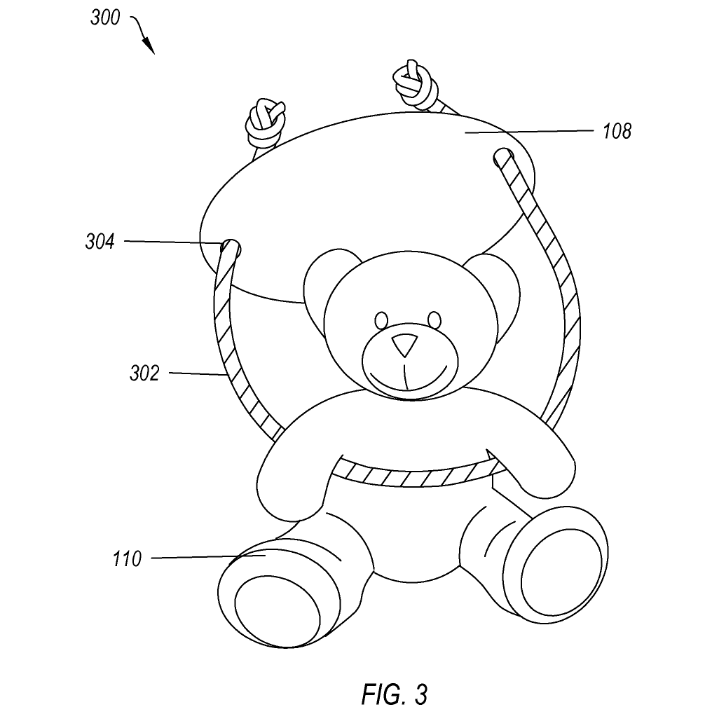

FIG. 3 illustrates an alternative system 300 for customizing a cloth. In at least one implementation, the system 300 can allow a user to place a 3D object within the system 300. I.e., a 3D object can be place in the system 300 and attached the cloth, as desired by the user. In particular, the system 300 can secure the decoration 110 and be secured, in turn, to the cloth, securing the decoration 110 to the cloth.

FIG. 3 shows that the system 300 can include an attachment 302. In at least one implementation, the attachment 302 can allow the decoration 110 to be secured to the cloth via the first portion. For example, the attachment 302 can include a string, elastic or any other desired attachment 302. Additionally or alternatively, the attachment 302 can include decorative material. For example, the attachment 302 can be decorated to compliment the decoration 110.

FIG. 3 also shows that the second portion 108 can include one or more holes 304. In at least one implementation, the one or more holes 304 can allow an external object to be secured to the system 300. In particular, the holes 304 can receive the attachment 302 securing the decoration 110 to the second portion 108 and thus the cloth.

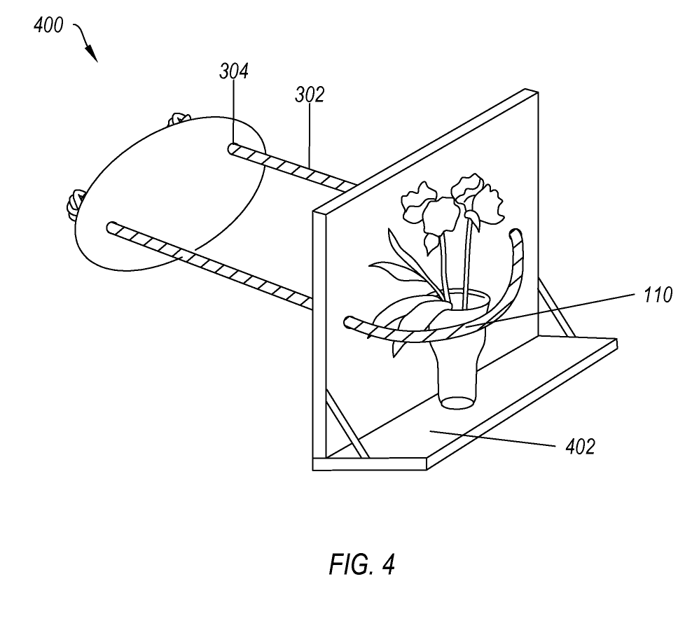

FIG. 4 illustrates the alternative system 300 for customizing a cloth indirectly securing the 3D decoration 110. I.e., the 3D decoration 110 can be indirectly secured to the system 300 and attached the cloth using an intermediate apparatus, as desired by the user. In particular, the system 300 can secure the intermediate apparatus which, in turn, secures the 3D decoration 110.

FIG. 4 further shows that the system 300 can include a base 402. In at least one implementation, the base 402 can provide a foundation or resting place for the decoration 110. I.e., the decoration 110 can be placed on the base 402 and secured using the attachment 302. The base 402 can include any desired configuration. For example, the base 402 can include an L-shaped shelf. Additionally or alternatively, the base 402 can include decorative material. For example, the base 402 can be painted or otherwise decorated to compliment the decoration 110.

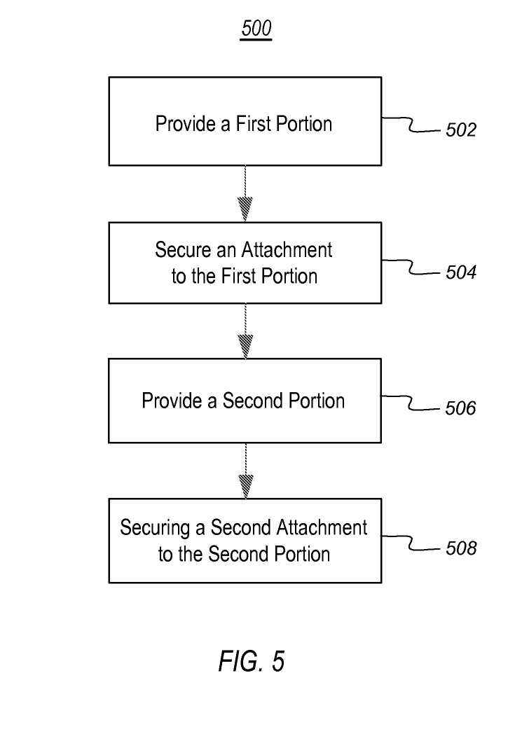

FIG. 5 is a flow chart illustrating a method 500 of manufacturing a system for customizing a cloth. In at least one implementation, the system can include the system 100 of FIGS. 1-2. Therefore, the method 500 will be described, exemplarily, with reference to the system 100 of FIGS. 1-2. Nevertheless, one of skill in the art can appreciate that the method 500 can be used to produce a system other than the system 100 of FIGS. 1-2.

FIG. 5 shows that the method 500 can include providing 502 a first portion. In at least one implementation, the first portion serves as a “base” or support for a decorative item to be attached to the cloth. The first portion can be sized to accommodate the desired weight. I.e., the first portion can be smaller for smaller objects and larger for larger objects. Additionally or alternatively, the first portion can be shaped as desired. For, example, the first portion can include a rounded shape to prevent sharp edges.

FIG. 5 also shows that the method 500 can include securing 504 an attachment to the first portion. In at least one implementation, the attachment is configured to attach the first portion to the cloth. In particular, the attachment secures the first portion to the cloth and other elements of the system can then be secured to the first portion.

FIG. 5 further shows that the method 500 can include providing 506 a second portion. In at least one implementation, the second portion is configured to attach to the first portion. For example, the first portion and the second portion can be magnetically attracted to one another. Additionally or alternatively, the first portion and the second portion can include a hook and loop fastener, a pin, a snap, a button, adhesive or any other desired connection.

FIG. 5 additionally shows that the method 500 can include securing 508 a second attachment to the second portion. In at least one implementation, the second attachment can secure the decoration to the second portion. For example, the second attachment can include an adhesive layer. The adhesive layer can include a pressure sensitive adhesive. Pressure sensitive adhesive (PSA, self-adhesive, self-stick adhesive) is adhesive which forms a bond when pressure is applied to marry the adhesive with the adherend. I.e., no solvent, water, or heat is needed to activate the adhesive. Additionally or alternatively, the second attachment can include a string or elastic material for securing a 3D decoration.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

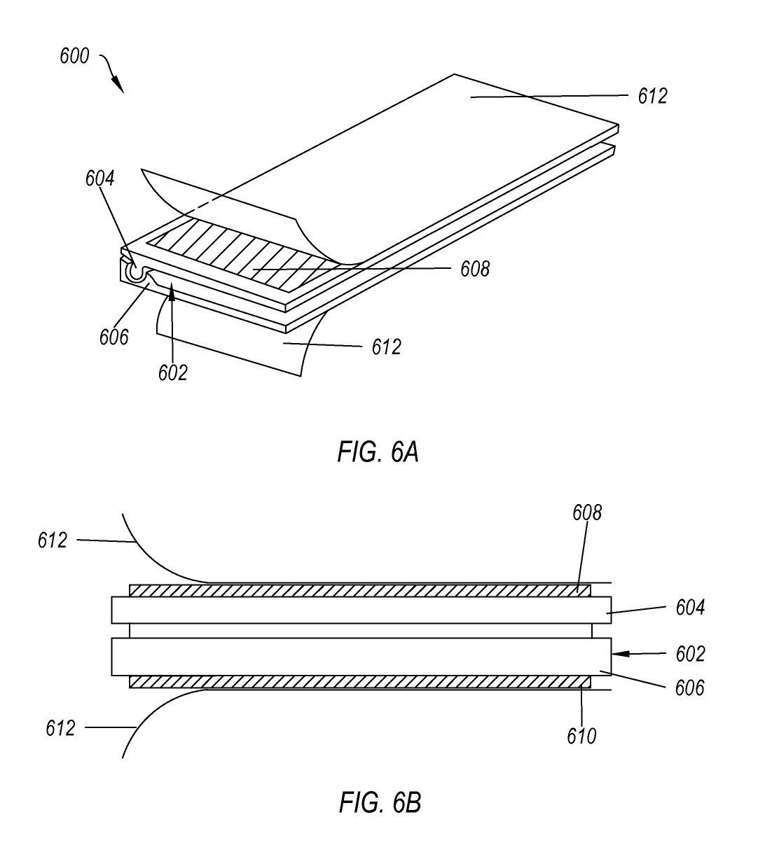

FIGS. 6A and 6B illustrate an alternative example of a system 600 for customizing a cloth 102. FIG. 6A illustrates a top perspective view of the alternative system 600 for customizing a cloth 102; and FIG. 6B illustrates a side view of the alternative system 600 for customizing a cloth 102. In at least one implementation, the cloth 102 can include clothing, other cloth and cloth-like materials. I.e., the system 100 can allow a user to customize the look of his/her clothing. Additionally or alternatively, the system 100 can allow the user to customize upholstery or other furniture coverings. One of skill in the art will appreciate that any cloth 102 can be customized and that clothing and cloth are examples and not limiting herein unless otherwise specified in the claims.

FIGS. 6A and 6B show that that the system 600 can include an interlocking fastener 602. In at least one implementation, the interlocking fastener 602 can be made of any desired material. For example, the interlocking fastener 602 can include plastic. The interlocking fastener 602 can create a releasable connection that can be released by the user. I.e., the user can separate the interlocking fastener 602 when desired. For example, if the user wishes to wash the cloth.

FIGS. 6A and 6B also show that the interlocking fastener 602 can include a male end 604 and a female end 606. The male end 604 can include a protruding portion which mates with a concave portion of the female end 606. I.e., the male end 604 can include a portion which mates with the female end 606 locking the male end 604 and the female end 606 to one another until sufficient separating force has been applied.

FIGS. 6A and 6B further show that the system 600 can include a first adhesive layer 608 on the male end 604. In at least one implementation, the first adhesive layer 608 is configured to attach the male end 604 to a cloth or a decoration. I.e., the first adhesive layer 608 can attach the male end 604, and structures attached thereto, to the cloth using the female end 606 or vice versa. For example, the first adhesive layer 608 can include a pressure sensitive adhesive.

FIGS. 6A and 6B additionally show that the system 600 can include a second adhesive layer 610 on the female end 606. In at least one implementation, the second adhesive layer 610 is configured to attach the female end 606 to a cloth or decoration. I.e., the second adhesive layer 610 can attach the female end 606, and structures attached thereto, to the cloth using the male end 604 or vice versa. The second adhesive layer 610 can include the same adhesive as the first adhesive layer 608 or a different adhesive.

FIGS. 6A and 6B also show that the system 600 can include a backing 612. In at least one implementation, the backing 612 can protect the adhesive until the desired time of use. I.e., the backing 612 can include a material which attaches to either the first adhesive layer 608 or the second adhesive layer 610, but does not remove the adhesive layer. The backing 612 can include any desired material. For example, the backing 612 can include a waxed paper.

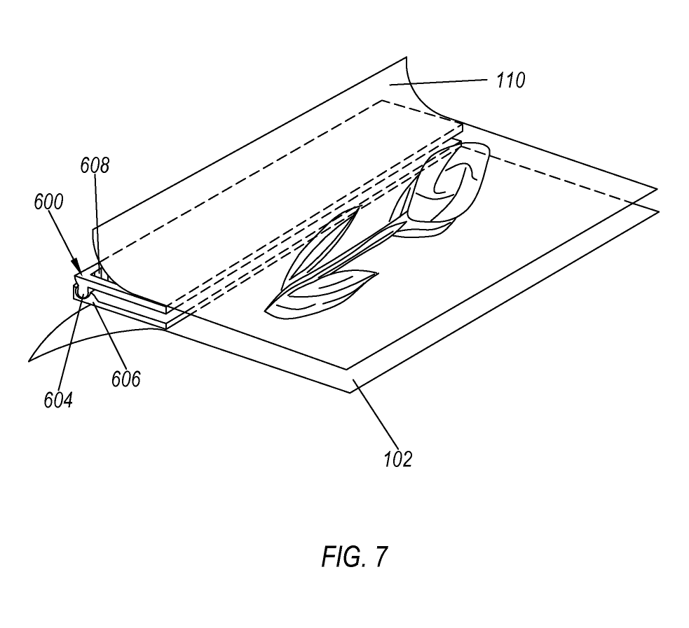

FIG. 7 illustrates an example of the system 600 attaching a decoration 110 to a cloth 102. For example, the male end 604 can be attached to the cloth 102 using the first adhesive layer 608. Likewise, the female end 606 is attached to the decoration 110 using the second adhesive layer. The male end 604 is then attached the female end 606, securing the decoration 110 to the cloth 102.

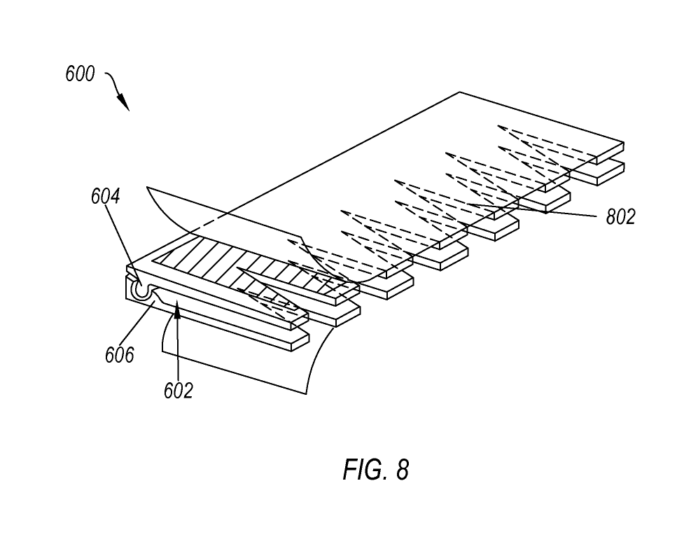

FIG. 8 illustrates that the system 600 can include one or more notches 802. In at least one implementation, the one or more notches 802 can allow the male end 604 and the female end 606 to flex. I.e., the notches 802 allow the male end 604 and the female end 606 to bend about the notches 802, allowing the system 600 to be formed into any desired shape. I.e., rather than having a straight edge, the interlocking fastener 602 can be customized to fit the edge of the cloth and/or the decoration.

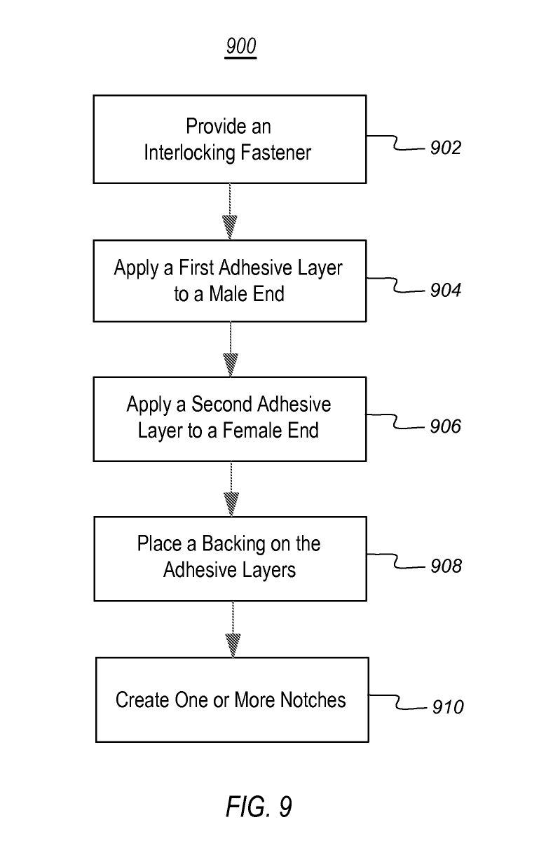

FIG. 9 is a flow chart illustrating a method 900 of manufacturing a system for customizing a cloth. In at least one implementation, the system can include the system 600 of FIGS. 6-8. Therefore, the method 900 will be described, exemplarily, with reference to the system 600 of FIGS. 6-8. Nevertheless, one of skill in the art can appreciate that the method 900 can be used to produce a system other than the system 600 of FIGS. 6-8.

FIG. 9 shows that the method 900 can include providing 902 an interlocking fastener. In at least one implementation, the interlocking fastener can be made of any desired material. For example, the interlocking fastener can include plastic. The interlocking fastener can create a releasable connection that can be released by the user. I.e., the user can separate the interlocking fastener when desired. For example, if the user wishes to wash the cloth.

In at least one implementation, the interlocking fastener can include a male end and a female end. The male end can include a protruding portion which mates with a concave portion of the female end. I.e., the male end can include a portion which mates with the female end locking the male end and the female end to one another until sufficient separating force has been applied.

FIG. 9 also shows that the method 900 can include applying 904 a first adhesive layer on the male end. In at least one implementation, the first adhesive layer is configured to attach the male end to a cloth or a decoration. I.e., the first adhesive layer can attach the male end, and structures attached thereto, to the cloth using the female end or vice versa. For example, the first adhesive layer can include a pressure sensitive adhesive.

FIG. 9 also shows that the method 900 can include applying 906 a second adhesive layer on a female end. In at least one implementation, the second adhesive layer is configured to attach the female end to a cloth or decoration. I.e., the second adhesive layer can attach the female end, and structures attached thereto, to the cloth using the male end or vice versa. The second adhesive layer can include the same adhesive as the first adhesive layer or a different adhesive.

FIG. 9 further shows that the method 900 can include placing 908 a backing on the adhesive layers. In at least one implementation, the backing can protect the adhesive until the desired time of use. I.e., the backing can include a material which attaches to either the first adhesive layer or the second adhesive layer, but does not remove the adhesive layer. The backing can include any desired material. For example, the backing can include a waxed paper.

FIG. 9 additionally shows that the method 900 can include creating 910 one or more notches. In at least one implementation, the one or more notches can allow the male end and the female end to flex. I.e., the notches allow the male end and the female end to bend about the notches, allowing the system to be formed into any desired shape. I.e., rather than having a straight edge, the interlocking fastener can be customized to fit the edge of the cloth and/or the decoration.

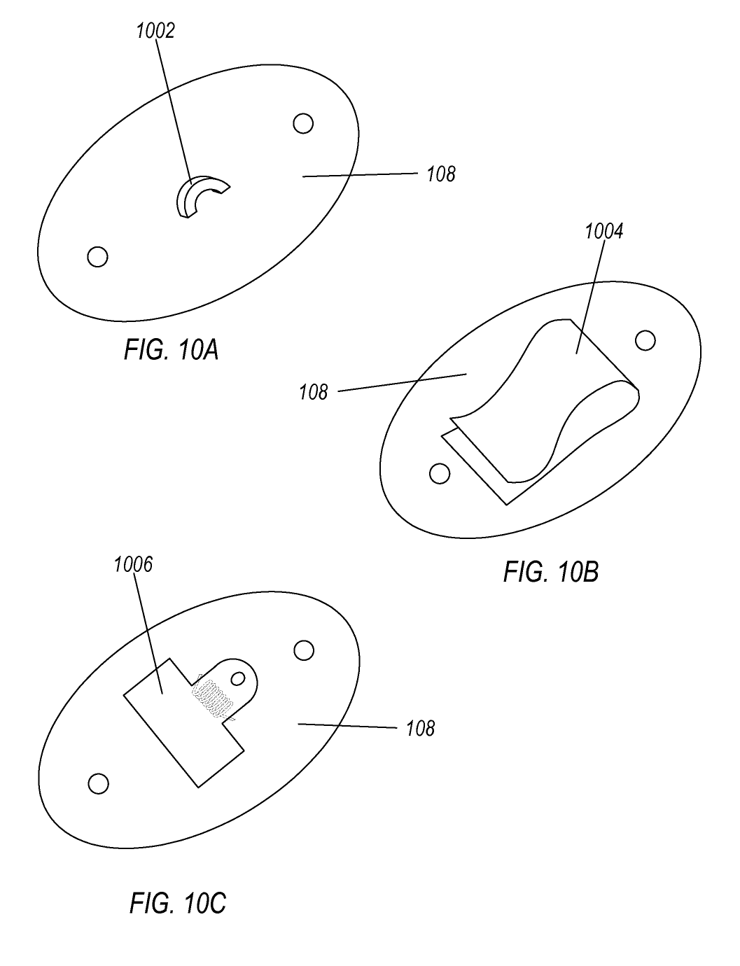

FIGS. 10A, 10B and 10C illustrate alternative examples of an attachment for attaching a second portion 108 to an external object. FIG. 10A illustrates an arch 1002 for attaching the second portion 108 to an external object. FIG. 10B illustrates a clip 1004 for attaching the second portion 108 to an external object. FIG. 10C illustrates a spring loaded clip 1006 for attaching the second portion 108 to a external object. One of skill in the art will appreciate that the attachments shown are exemplary and other attachments are contemplated herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for attaching an external object to a cloth, the system comprising:
a badge;
a first attachment, wherein the attachment is configured to releasably attach a cloth to the badge; and
a second attachment, wherein the second attachment is configured to releasably attach a decoration to the badge.

2. The system of claim 1, wherein the first attachment includes an adhesive layer.

3. The system of claim 2 further comprising a backing, wherein the backing is configured to protect the adhesive layer.

4. The system of claim 2, wherein the adhesive layer includes a pressure sensitive adhesive.

5. The system of claim 2 further comprising:
a base layer, attached to the adhesive layer; and
a second adhesive layer, wherein the third adhesive layer:
is applied to the base layer opposite the adhesive layer; and
is configured to releasably attach the base layer to the cloth.

6. The system of claim 1 further comprising a cloth attached to the first attachment.

7. The system of claim 6, wherein the cloth includes an article of clothing.

8. The system of claim 7, wherein the cloth includes a fabric.

9. The system of claim 1, wherein the badge includes:
a first portion; and
a second portion;
wherein, the second portion is configured to releasably attach to the first portion.

10. The system of claim 1, wherein the second attachment includes an orifice, wherein the orifice is configured to receive a portion of the decoration.

11. The system of claim 1, wherein the second attachment includes:
a string, wherein the string is configured to secure the decoration; and
an orifice, wherein the orifice is configured to receive a portion of the string.

12. A system for attaching an external object to a cloth, the system comprising:
a badge, wherein the badge includes:
a first portion; and
a second portion;
wherein, the second portion is configured to releasably attach to the first portion;
a first attachment, wherein the first attachment:
is secured to the first portion; and
is configured to releasably attach a cloth to the first portion; and
a second attachment, wherein the second attachment;
is secured to the second portion; and
is configured to releasably attach a decoration to the second portion.

13. The system of claim 12, wherein the first attachment includes a safety pin.

14. The system of claim 12, wherein;
the first portion includes a first portion of a hook and look fastener; and
the second portion includes a second portion of a hook and loop fastener.

15. The system of claim 12, wherein the second portion includes a magnetic material.

16. The system of claim 12, wherein the second attachment includes an adhesive layer.

17. A method for manufacturing a system for attaching an external object to a cloth, the method comprising:
providing a badge
securing a first attachment, wherein the first attachment:
is secured to the badge; and
is configured to releasably attach a cloth to the badge; and
securing a second attachment, wherein the second attachment;
is secured to the second attachment; and
is configured to releasably attach a decoration to the badge.

18. The method of claim 17, wherein the first attachment includes at least one of:
a hook and loop fastener;
a pin;
a snap; or
a button.

19. The method of claim 17, wherein the badge includes:
a first portion; and
a second portion;
wherein, the second portion is configured to releasably attach to the first portion.

20. The method of claim 17 further comprising a releasable seal, wherein the first attachment includes the releasable attachment between the second portion and the first portion.
